(19) United States
(12) Patent Application Publication
(10) Pub. No.: US 2012/0269929 A1
(43) Pub. Date: Oct. 25, 2012

(54) Fortified Milk-Based Nutritional Compositions

(76) Inventors: HUGH LIPPMAN, EVANSVILLE, IN (US); ZAFIR GAYGADZHIEV, NEWBURGH, IN (US); LINDA O'RISKY, EVANSVILLE, IN (US); CATHY WEIR, EVANSVILLE, IN (US)

(21) Appl. No.: 13/092,186

(22) Filed: Apr. 22, 2011

(51) Int. Cl. A23C 9/20

(52) U.S. Cl. 426/71; 426/580

(57) ABSTRACT

A nutritional composition which includes up to about 5.5 g/100 kcal of a fat or lipid source; up to about 6 g/100 kcal of a protein source; and a source of carbohydrates such that the nutritional composition has up to about 18 g/100 kcal of total carbohydrates, wherein at least 60% of the total carbohydrates comprises fructose, lactose or combinations thereof.

### BACKGROUND

1. Technical Field

This disclosure relates generally to the field of nutritional compositions, such as fortified milk-based nutritional compositions for children, that contain a fat or lipid source, a carbohydrate source, and a protein source.

2. Background

There are currently a variety of dietary compositions that seek to support the normal growth and development of children as well as to promote their life-long health. Often such dietary compositions contain a large number of carbohydrates, both naturally occurring and refined, to provide nutrients to the growing child.

Despite the prevalence of carbohydrates in dietary compositions for young humans, the significance of the source and composition of those carbohydrates is often ignored. Thus, an object of the present disclosure is to provide a nutritional composition that has a targeted carbohydrate composition.

### BRIEF SUMMARY

Briefly, the present disclosure is directed, in an embodiment, to a nutritional composition comprising lactose and, optionally, fructose. In an embodiment, the nutritional composition is a fortified milk-based nutritional composition for a child and includes:

a. up to about 5.5 g/100 kcal of a fat or lipid source, more preferably from about 1 g/100 kcal to about 4.5 g/100 kcal of a fat or lipid source;
b. up to about 6 g/100 kcal of a protein source, more preferably from about 2 g/100 kcal to about 5 g/100 kcal of a protein source; and
c. a source of carbohydrates such that the nutritional composition comprises up to about 18 g/100 kcal of total carbohydrates, wherein at least 60% by weight of the total carbohydrates comprise lactose, fructose or combinations thereof. In some embodiments, the nutritional composition comprises a growing up milk for children.

Preferably, the nutritional composition comprises from about 11.5 g/100 kcal to about 16 g/100 kcal of total carbohydrates, more preferably from about 12 g/100 kcal to about 15.5 g/100 kcal of total carbohydrates.

In certain embodiments, the carbohydrate source contains less than about 0.5 g/100 kcal of added sucrose. In other embodiments, the carbohydrate source includes less than about 2.0 g/100 g of added sucrose. In addition, the carbohydrate source preferably contains less than about 1 g/100 kcal maltodextrin and/or less than about 6 g/100 kcal corn syrup solids. In other embodiments, the carbohydrate source includes no added sucrose, no added corn syrup solids and/or no added maltodextrin. In certain embodiments, the nutritional composition has a glycemic index of less than about 60.

### DETAILED DESCRIPTION

As noted, the present disclosure relates to a nutritional composition, such as a fortified milk-based nutritional composition for a child, and includes:

a. up to about 5.5 g/100 kcal of a fat or lipid source, preferably about 1 g/100 kcal to about 5.5 g/100 kcal of a fat or lipid source, and more preferably from about 1 g/100 kcal to about 4.5 g/100 kcal of a fat or lipid source;
b. up to about 6 g/100 kcal of a protein source, preferably about 2 g/100 kcal to about 6 g/100 kcal of a protein source, and more preferably from about 2 g/100 kcal to about 5 g/100 kcal of a protein source; and
c. a source of carbohydrates, wherein the nutritional composition comprises up to about 18 g/100 kcal of total carbohydrates, and further wherein lactose and fructose comprise at least about 60% of the total carbohydrates, when expressed as a weight percentage. In some embodiments, the nutritional composition comprises a growing up milk for children.

As used herein, “total carbohydrates” relates to carbohydrates which are present in the nutritional composition both by way of their inclusion in other components or ingredients of the composition (so-called endogenous carbohydrates), as well as carbohydrates added themselves (so-called added carbohydrates). For instance, when bovine milk protein sources are employed, they contain carbohydrates, which would be classified as endogenous carbohydrates. Also, as used herein, a “child” and “children” are defined as humans over the age of 12 months to about 12 years old.

Preferably, the nutritional composition comprises from about 11.5 g/100 kcal to about 16 g/100 kcal of total carbohydrates, more preferably from about 12 g/100 kcal to about 15.5 g/100 kcal of total carbohydrates.

In some embodiments, the total carbohydrates comprise at least about 60% by weight lactose. More preferably, the total carbohydrates comprise at least about 70% or at least about 80% by weight lactose. For example, the total carbohydrates may comprise from about 60% to about 100% by weight lactose. Lactose may be present as an element of other components present in the disclosed nutritional composition (referred to as endogenous lactose), or it may be separately added. Most commonly, the lactose will be a combination of both endogenous lactose and added lactose.

In embodiments of the nutritional composition of the present disclosure where fructose is present, the combined amount of lactose and fructose present in the total carbohydrates preferably is greater than or equal to about 60% of the weight of the total carbohydrates. More preferably, the combined amount of lactose and fructose is greater than or equal to about 70% of the weight of the total carbohydrates. Preferably, in such embodiments, the total carbohydrates comprises at least about 5%, more preferably at least about 10%, by weight fructose; more specifically, in some embodiments, the total carbohydrates comprises from about 10% to about 25% by weight fructose.

In yet other embodiments, the nutritional composition of the present disclosure includes between about 10.5 g/100 g and about 19 g/100 g of a fat or lipid source; between about 14 g/100 g and about 21 g/100 g of a protein source; and between about 54 g/100 g and 68 g/100 g of total carbohydrates, wherein lactose and fructose comprise at least about 60% of the total carbohydrates, when expressed as a weight percentage.

The total lactose (endogenous and added) present in some embodiments of the nutritional composition of the present disclosure is from about 6.0 g/100 kcal and about 11.7 g/100 kcal, more preferably from about 6.5 g/100 kcal and about 11.2 g/100 kcal. The added lactose is between about 0.8 g/100 kcal to 5.4 g/100 kcal, more preferably from about 2.5 g/100 kcal and about 5.2 g/100 kcal.

In some embodiments, the total lactose is between about 29 g/100 g and about 48 g/100 g of the nutritional composition, more preferably between about 30.5 g/100 g and about 46 g/100 g. The added lactose is advantageously between about 3.5 g/100 g and about 18.5 g/100 g of the nutritional composition, more preferably between about 9.5 g/100 g and about 17 g/100 g.

The fructose present in certain embodiments of the nutritional composition is up to about 3.6 g/100 kcal, more preferably from about 1.4 g/100 kcal to about 3.2 g/100 kcal. In other embodiments, the fructose is up to about 12.5 g/100 g, more preferably from about 7 g/100 g and about 12 g/100 g.

Fructose and lactose have a glycemic index (GI) lower than certain bulking ingredients and sweeteners commonly used in nutritional compositions such as corn syrup solids, sucrose and maltodextrin. Thus, in certain embodiments, the nutritional compositions offer the advantage of possessing a low glycemic index. For example, in certain embodiments, the nutritional compositions have a glycemic index of less than about 60, such as between about 15 and about 60 (more preferably from about 15 to about 55, and in some embodiments, less than about 41, less than about 36, or less than about 25).

As known in the art, the glycemic index (GI) distinguishes carbohydrates that have a tendency to break down quickly during digestion and release glucose rapidly into the bloodstream—so-called high glycemic index carbohydrates—from carbohydrates that break down more slowly and release glucose more gradually into the bloodstream. Carbohydrates that fall into the latter category—so-called low glycemic index carbohydrates—are often seen as potentially advantageous in controlling glucose.

The glycemic index of a nutritional composition is determined by administering to ten healthy people, 50 grams of glucose on one occasion (the glucose reference composition) and the nutritional composition on another occasion. The amount of nutritional composition that is administered is such that it contains 50 grams of available carbohydrate. Blood samples are then taken over the next two hours after administration of the nutritional and glucose reference compositions and used to construct a glucose response curve. The area under the curve (AUC) is then calculated and reflects the total rise in blood sugar (glucose) levels after administering the nutritional composition or the glucose reference composition. For each subject, the AUC of the nutritional composition is divided by the AUC of the glucose reference composition and multiplied by 100 to arrive at a glycemic index for each subject. The glycemic index observed for the subjects are averaged to determine the glycemic index value of the nutritional composition.

A lower glycemic response typically results in a more sustained release of glucose into the blood. Thus, in embodiments of the disclosure that provide nutritional compositions with a low glycemic index, such compositions may be administered to a child as a method of supporting sustained mental energy, improved cognitive development and/or improved cognitive function, as well as healthy growth.

In addition to lactose and, optionally, fructose, the nutritional compositions can include additional lower glycemic index carbohydrate bulking ingredients, including but not limited to resistant starch, fibers, and/or prebiotics, and/or additional lower glycemic index sweeteners, including but not limited to isomaltulose (palitinose), tagatose, sugar alcohols, and/or non-nutritive sweeteners.

As noted, the nutritional compositions of the disclosure include a fat or lipid source. Suitable fat or lipid sources for practicing the present disclosure may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palmolein, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

The nutritional compositions of the disclosure further includes a protein source. Protein sources useful in practicing the present disclosure include, but are not limited to, bovine milk protein sources such as milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, rennet casein, buttermilk powders, co-precipitate milk powders, potassium caseinate, caseinate (e.g. sodium caseinate, sodium calcium caseinate, calcium caseinate) and any combinations thereof. In an embodiment, the protein source comprises from about 10% to about 40% whey protein. In another embodiment, the protein source comprises from about 50% to about 80% caseins.

In one embodiment, the proteins are provided as intact proteins. In other embodiments, the proteins are provided as a combination of both intact proteins and partially hydrolyzed proteins, with a degree of hydrolysis of between about 4% and 10%. In yet another embodiment, the protein source may be supplemented with glutamine-containing peptides.

The fortified milk-based nutritional compositions of the present disclosure may be in any form. Preferably, the fortified milk-based nutritional composition is in liquid form or in a powdered form. Preferably, if provided in powdered form, the nutritional composition is reconstituted in a liquid such as water prior to administration to a person. Preferably, the nutritional compositions are administered to a child as part of a diverse diet. More preferably, the nutritional compositions are administered to a child between the ages of about 1 year to about 12 years. It is also preferred that the nutritional compositions possess acceptable sensory and organoleptic properties, such as an acceptable taste, texture and/or smell.

In a preferred embodiment of the disclosure, the fortified milk-based nutritional composition is a growing up milk or a product (such as a powder) that produces a growing up milk upon reconstitution in a liquid (such as water). As known to those of ordinary skill, the term “growing up milk” refers to a category of fortified milk-based beverages intended to be used as part of a diverse diet in order to support the normal growth and development of children. Growing up milks are well-known in the art and, include, without limitation, Enfagrow® and Enfakid® sold by Mead Johnson Nutrition.

If in the form of a growing up milk, the nutritional composition may provide, for example, from about 60 kcal to about 75 kcal of energy per 100 ml. In such an embodiment, the amounts and types of proteins, lipids and carbohydrates may vary. For example, protein may comprise from about 2 to about 5 g/100 kcal, with carbohydrates providing from about 11 to about 14 g/100 kcal and lipids comprising from about 2 to about 4 g/100 kcal.

The growing up milk may further include a number of vitamins, minerals and micronutrients, including without limitation, those described in U.S. Patent Publication 2010/0104727, which is hereby incorporated by reference in its entirety. Such vitamins, minerals and micronutrients may include, without limitation, vitamin A, vitamin C, thiamin, riboflavin, vitamin B6, folic acid, vitamin D, calcium, iron, zinc, iodine, vitamin E, vitamin K, pantothenic acid, niacin, biotin, vitamin B12, choline, potassium, magnesium, phosphorus, chloride, copper, selenium, and/or fluoride. Preferably, the growing up milk contains from about 10% to about 100% of the country-specific requirements per serving of one or more of vitamin A, vitamin C, thiamin, riboflavin, vitamin B6, folic acid, vitamin D, calcium, iron, zinc, and/or iodine. For instance, in the U.S., from about 10% to about 30% of the Estimated Average Requirement (EAR) per serving of one or more of vitamin A, vitamin C, thiamin, riboflavin, vitamin B6, folate, vitamin D, calcium, iron, zinc, and/or iodide is provided.

The nutritional composition of the present disclosure may also include one or more prebiotics which are generally considered part of total carbohydrates. As used herein, the term “prebiotic” means a non-digestible food ingredient that beneficially affects the host by selectively stimulating the growth and/or activity of one or a limited number of bacteria in the colon that can improve the health of the host. A “prebiotic composition” is a composition that comprises one or more prebiotics. Such prebiotics may be naturally-occurring, synthetic, or developed through the genetic manipulation of organisms and/or plants, whether such new source is now known or developed later.

Prebiotics useful in the present disclosure may include oligosaccharides, polysaccharides, and other prebiotics that contain fructose, xylose, soya, galactose, glucose and mannose. More specifically, prebiotics useful in the present disclosure may include lactulose, lactosucrose, raffinose, gluco-oligosaccharide, inulin, polydextrose, polydextrose powder, galacto-oligosaccharide, fructo-oligosaccharide, isomalto-oligosaccharide, soybean oligosaccharides, lactosucrose, xylo-oligosacchairde, chito-oligosaccharide, manno-oligosaccharide, aribino-oligosaccharide, siallyl-oligosaccharide, fuco-oligosaccharide, and gentio-oligosaccharides. Preferably, the nutritional compositions comprise polydextrose, galacto-oligosaccaharide, fructo-oligosaccharide and/or inulin. For instance, the nutritional compositions can comprise a combination of polydextrose with galacto-oligosaccaharide or fructo-oligosaccharide with inulin; alternatively, the prebiotic combination can include polydextrose with fructo-oligosaccharide or inulin with galacto-oligosdaccharide. In certain embodiments, the prebiotic included in the compositions of the present disclosure include those taught by U.S. Pat. No. 7,572,474, the disclosure of which is incorporated herein by reference.

If included in the nutritional compositions, the total amount of prebiotics present in the nutritional composition may be from about 0.1 g/100 kcal to about 2 g/100 kcal. More preferably, the total amount of prebiotics present in the nutritional composition may be from about 0.3 g/100 kcal to about 1 g/100 kcal.

If polydextrose is used in the prebiotic composition, the amount of polydextrose in the nutritional composition may, in an embodiment, be within the range of from about 0.1 g/100 kcal to about 1.0 g/100 kcal. In another embodiment, the amount of polydextrose is within the range of from about 0.2 g/100 kcal to about 0.5 g/100 kcal.

If galacto-oligosaccharide is used in the prebiotic composition, the amount of galacto-oligosaccharide in the nutritional composition may, in an embodiment, be from about 0.1 g/100 kcal to about 0.5 g/100 kcal. In another embodiment, the amount of galacto-oligosaccharide in the nutritional composition may be from about 0.2 g/100 kcal to about 0.5 g/100 kcal. In certain embodiments, the ratio of polydextrose to galacto-oligosaccharide in the prebiotic composition is between about 9:1 and about 1:9.

In one embodiment of the disclosure, the nutritional composition may contain one or more probiotics. A “probiotic” is a microorganism with low or no pathogenicity that exerts beneficial effects on the health of the host. Any probiotic known in the art may be acceptable in this embodiment provided it achieves the intended result. In a particular embodiment, the probiotic may be selected from Lactobacillus species, Lactobacillus rhamnosus GG, Bifidobacterium species, Bifidobacterium longum, Bifidobacterium brevis and Bifidobacterium animalis subsp. lactis BB-12.

If included in the composition, the amount of the probiotic may vary from about 10⁴ to about 10¹⁰ colony forming units (cfu) per kg body weight per day. In another embodiment, the amount of the probiotic may vary from about 10⁶ to about 10⁹ cfu per kg body weight per day. In yet another embodiment, the amount of the probiotic may be at least about 10⁶ cfu per kg body weight per day. In other embodiments, the probiotic is present in the nutritional composition of the present disclosure in an amount of between 1×10⁷ to about 1×10⁹ cfu/g of product.

In an embodiment, one or more of the probiotics is viable. In another embodiment, one or more of the probiotics is non-viable. As used herein, the term “viable” refers to live microorganisms. The term “non-viable” or “non-viable probiotic” means non-living probiotic microorganisms, their cellular components and metabolites thereof. Such non-viable probiotics may have been heat-killed or otherwise inactivated but retain the ability to favorably influence the health of the host. The probiotics useful in the present disclosure may be naturally-occurring, synthetic or developed through the genetic manipulation of organisms, whether such new source is now known or later developed.

The nutritional formulation of the disclosure, in some embodiments, may further contain a source of long chain polyunsaturated fatty acids (LCPUFAs). Preferably, the source of LCPUFAs comprise docosahexanoic acid (DHA). Other suitable LCPUFAs include, but are not limited to, α-linoleic acid, γ-linoleic acid, linoleic acid, α-linolenic acid, eicosapentanoic acid (EPA) and arachidonic acid (ARA).

In some embodiments, the LCPUFA included in the nutritional composition is DHA, present at a level of from about 5 mg/100 kcal to about 20 mg/100 kcal, more preferably from about 6.5 mg/100 kcal to about 16 mg/100 kcal.

In another embodiment, the nutritional composition is supplemented with both DHA and ARA. In this embodiment, the weight ratio of ARA:DHA may be from about 1:3 to about 9:1. In one embodiment of the present disclosure, the weight ratio of ARA:DHA is from about 1:2 to about 4:1.

The nutritional composition may be supplemented with oils containing DHA (ARA as well) using standard techniques known in the art. For example, DHA may be added to the composition by replacing an equivalent amount of an oil, such as high oleic sunflower oil, normally present in the composition. As another example, the oils containing DHA may be added to the composition by replacing an equivalent amount of the rest of the overall fat blend normally present in the composition without DHA.

If utilized, the source of DHA may be any source known in the art such as marine oil, fish oil, single cell oil, egg yolk lipid, and brain lipid. In some embodiments, the DHA are sourced from the single cell Martek oil DHASCO®, or variations thereof. The DHA can be in natural form, provided that the remainder of the LCPUFA source does not result in any substantial deleterious effect on the infant. Alternatively, the DHA can be used in refined form.

In an embodiment of the present disclosure, sources of DHA are single cell oils as taught in U.S. Pat. Nos. 5,374,567; 5,550,156; and 5,397,591, the disclosures of which are incorporated herein in their entirety by reference. However, the present disclosure is not limited to only such oils.

The nutritional composition of the disclosure also includes lactoferrin in some embodiments. Lactoferrins are single chain polypeptides of about 80 kD containing 1-4 glycans, depending on the species. The 3-D structures of lactoferrin of different species are very similar, but not identical. Each lactoferrin comprises two homologous lobes, called the N- and C-lobes, referring to the N-terminal and C-terminal part of the molecule, respectively. Each lobe further consists of two sub-lobes or domains, which form a cleft where the ferric ion (Fe³⁺) is tightly bound in synergistic cooperation with a (bi)carbonate anion. These domains are called N1, N2, C1 and C2, respectively. The N-terminus of lactoferrin has strong cationic peptide regions that are responsible for a number of important binding characteristics. Lactoferrin has a very high isoelectric point (˜pI 9) and its cationic nature plays a major role in its ability to defend against bacterial, viral, and fungal pathogens. There are several clusters of cationic amino acids residues within the N-terminal region of lactoferrin mediating the biological activities of lactoferrin against a wide range of microorganisms. For instance, the N-terminal residues 1-47 of human lactoferrin (1-48 of bovine lactoferrin) are critical to the iron-independent biological activities of lactoferrin. In human lactoferrin, residues 2 to 5 (RRRR) and 28 to 31 (RKVR) are arginine-rich cationic domains in the N-terminus especially critical to the antimicrobial activities of lactoferrin. A similar region in the N-terminus is found in bovine lactoferrin (residues 17 to 42; FKCRRWQWRMKKLGAPSITCVRRAFA).

As described in “Perspectives on Interactions Between Lactoferrin and Bacteria” which appeared in the publication BIOCHEMISTRY AND CELL BIOLOGY, pp 275-281 (2006), lactoferrins from different host species may vary in their amino acid sequences though commonly possess a relatively high isoelectric point with positively charged amino acids at the end terminal region of the internal lobe. Suitable lactoferrins for use in the present disclosure include those having at least 48% homology with the amino acid sequence AVGEQELRKCNQWSGL at the HLf (349-364) fragment. For example, suitable lactoferrins include, without limitation, human lactoferrin, bovine lactoferrin, porcine lactoferrin, equine lactoferrin, buffalo lactoferrin, goat lactoferrin, murine lactoferrin and camel lactoferrin.

In a preferred embodiment, the lactoferrin is lactoferrin obtained from a non-human source. As used herein, “lactoferrin obtained from a non-human source” means lactoferrin which is from a source other than human breast milk. For example, in certain embodiments, the lactoferrin is human lactoferrin produced by a genetically modified organism and/or non-human lactoferrin. The term “non-human lactoferrin”, as used herein, refers to lactoferrin having an amino acid sequence that is different than the amino acid sequence of human lactoferrin.

In one embodiment, lactoferrin is present in the nutritional compositions in an amount of from about 5 mg/100 kcal to about 16 mg/100 kcal; in another embodiment, lactoferrin is present in an amount of about 9 mg/100 kcal to about 14 mg/100 kcal.

In certain embodiments, the nutritional composition of the present disclosure also comprises a beta-glucan. Beta glucans (β-glucans) are a diverse subset of glucose polymers, which are made up of chains of glucose monomers linked together via beta-type glycosidic bonds to form complex carbohydrates. β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

β-1,3; 1,6-glucans, are a polysaccharide fraction that prime immune surveillance in pediatric subjects, which may decrease microbial-related illnesses in children or infants by stimulating immune function when administered as part of a nutritional composition. Furthermore, β-glucans are well tolerated and do not produce or cause excess gas, abdominal distension, bloating or diarrhea in pediatric subjects. When administered orally, β-1,3-glucans are not directly absorbed by the metabolic processes of the digestion system. Indeed, significant systemic exposure following yeast β-glucan ingestion does not occur; however, small amounts of insoluble β-glucan particles are taken up by the Peyer's patches of the small intestine, and these particles subsequently enter the systemic circulation, as they are transported via macrophages. β-glucan may be included in the pediatric nutritional composition in an amount between about 3.5 mg/100 kcal to about 14 mg/100 kcal; alternatively, β-glucan may be present at a level of between about 0.010 and about 0.050 g/100 g of the composition.

In certain embodiments, natural and/or artificial flavors and flavorants can be included in the nutritional composition of the present disclosure, in order to make the composition more palatable to children. For instance, the composition can include vanilla, chocolate, honey, and other desirable flavors to increase the palatability of the nutritional composition to children.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although preferred embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged both in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

1. A milk-based nutritional composition comprising:
a) a fat or lipid source present at a level up to 5.5 g/100 kcal;
b) a bovine milk protein source present at a level of up to about 6 g/100 kcal; and
c) a source of carbohydrates, such that the nutritional composition comprises up to about 18 g/100 kcal of total carbohydrates, wherein at least 60% of the total carbohydrates comprises fructose and lactose.

2. The nutritional composition according to claim 1, wherein the total carbohydrates comprises at least about 10% by weight fructose.

3. The nutritional composition according to claim 1, wherein the total carbohydrates comprises at least about 60% by weight lactose.

4. The nutritional composition according to claim 1, wherein the combined amount of fructose and lactose present in the total carbohydrates is at least about 70% by weight.

5. The nutritional composition according to claim 1, wherein the total lactose in the nutritional composition is from about 6.0 g/100 kcal to about 11.7 g/100 kcal.

6. The nutritional composition according to claim 16, wherein the added lactose is from about 0.8 g/100 kcal to about 5.4 g/100 kcal.

7. The nutritional composition according to claim 5, wherein fructose is present in the nutritional composition at a level of up to about 3.6 g/100 kcal.

8. The nutritional composition according to claim 1, which comprises from about 11.5 g/100 kcal to about 16 g/100 kcal total carbohydrates, and further wherein lactose is present in the nutritional composition at a level of from about 6.5 g/100 kcal to about 11.2 g/100 kcal and fructose is present in the nutritional composition at a level of from about 1.4 g/100 kcal to about 3.2 g/100 kcal.

9. The nutritional composition according to claim 1, wherein the nutritional composition contains no added sucrose.

10. The nutritional composition according to claim 1, wherein the nutritional composition is a growing up milk.

11. The nutritional composition according to claim 1, wherein the nutritional composition further comprises a source of long chain polyunsaturated fatty acids.

12. The nutritional composition according to claim 11, wherein the source of long chain polyunsaturated fatty acids comprises docosahexanoic acid.

13. The nutritional composition according to claim 1, which further comprises at least one prebiotic at a level of from about 0.1 g/100 kcal to about 2 g/100 kcal.

14. The nutritional composition according to claim 13, wherein the at least one prebiotic comprises galacto-oligosaccharide, polydextrose, inulin, fructo-oligosaccharide or combinations thereof.

15. The nutritional composition according to claim 1, wherein the nutritional composition has a glycemic index of less than about 60.

16. The nutritional composition according to claim 5, wherein the total lactose comprises endogenous lactose, added lactose or combinations thereof.
